(19) United States
(12) Patent Application Publication
(10) Pub. No.: US 2015/0310869 A1
(43) Pub. Date: Oct. 29, 2015

(54) APPARATUS ALIGNING AUDIO SIGNALS IN A SHARED AUDIO SCENE

(71) Applicant: NOKIA CORPORATION, Espoo (FI)

(72) Inventors: Juha Petteri OJANPERA, NOKIA (FI); Igor Danilo Diego CURCIO, Tampere (FI)

(21) Appl. No.: 14/650,789

(22) PCT Filed: Dec. 13, 2012
(86) PCT No.: PCT/IB2012/057286

§ 371 Date: Jun. 9, 2015

(51) Int. Cl. G10L 19/00

(52) U.S. Cl. CPC G10L 19/00

(57) ABSTRACT

An apparatus comprising: an input selector configured to select at least two audio signals; a segmenter configured to segment the at least two audio signals according to at least two classifications; a segment selector configured to select, for the at least two audio signals, audio signal segments based on at least one classification from the at least two classifications; and an aligner configured to align the selected audio signal segments, and further configured to align the at least two audio signals based on the alignment of the selected audio signal segments.

### FIELD

The present application relates to apparatus for the processing of audio and additionally audio-video signals to enable sharing of audio scene captured audio signals. The invention further relates to, but is not limited to, apparatus for processing audio and additionally audio-video signals to enable sharing of audio scene captured audio signals from mobile devices.

### BACKGROUND

Viewing recorded or streamed audio-video or audio content is well known. Commercial broadcasters covering an event often have more than one recording device (video-camera/microphone) and a programme director will select a ‘mix’ where an output from a recording device or combination of recording devices is selected for transmission.

Multiple ‘feeds’ may be found in sharing services for video and audio signals (such as those employed by YouTube). Such systems, which are known and are widely used to share user generated content recorded and uploaded or up-streamed to a server and then downloaded or down-streamed to a viewing/listening user. Such systems rely on users recording and uploading or up-streaming a recording of an event using the recording facilities at hand to the user. This may typically be in the form of the camera and microphone arrangement of a mobile device such as a mobile phone.

Often the event is attended and recorded from more than one position by different recording users at the same time. The viewing/listening end user may then select one of the up-streamed or uploaded data to view or listen.

### SUMMARY

Aspects of this application thus provide a shared audio capture for audio signals from the same audio scene whereby multiple devices or apparatus can record and combine the audio signals to permit a better audio listening experience.

There is provided according to a first aspect an apparatus comprising at least one processor and at least one memory including computer code for one or more programs, the at least one memory and the computer code configured to with the at least one processor cause the apparatus to at least: select at least two audio signals; segment the at least two audio signals according to at least two classifications; select, for the at least two audio signals, audio signal segments based on at least one classification from the at least two classifications; align the selected audio signal segments; and align the at least two audio signals based on the alignment of the selected audio signal segments.

The apparatus may be further caused to generate a common time line incorporating the at least two audio signals.

The apparatus may be further caused to render an output audio signal from the aligned at least two audio signals.

Rendering an output audio signal from the aligned at least two audio signals may cause the apparatus to render segments for at least one of the at least two audio signals which match at least one defined rendering classification.

Rendering an output audio signal from the aligned at least two audio signals may cause the apparatus to: define a rending classification order and render segments for at least one of the at least two audio signals according to the rendering classification order.

Segmenting the at least two audio signals according to at least two classifications may cause the apparatus to define at least two classifications, a classification being defined according at least one feature value range.

Segmenting the at least two audio signals according to at least two classifications may cause the apparatus to: divide at least one of the audio signals into a number of frames; analyse for at least one frame of the number of frames of the at least one audio signal to determine at least one feature value; and determine a classification for the at least one frame based on at least one defined range of feature values, wherein the at least one of the audio signals is segmented according to the classification.

The classification for the at least one frame may be at least one of: music; speech; and noise.

Selecting, for the at least two audio signals, audio signal segments based on at least one classification from the at least two classifications may cause the apparatus to select audio signal segments with the music and/or speech classification.

Selecting, for the at least two audio signals, audio signal segments based on at least one classification from the at least two classifications may cause the apparatus to: define at least one selection classification; and select audio signal segments whose classification matches the at least one selection classification.

According to a second aspect there is provided an apparatus comprising: means for selecting at least two audio signals; means for segmenting the at least two audio signals according to at least two classifications; means for selecting, for the at least two audio signals, audio signal segments based on at least one classification from the at least two classifications; means for aligning the selected audio signal segments; and means for aligning the at least two audio signals based on the alignment of the selected audio signal segments.

The apparatus may further comprise means for generating a common time line incorporating the at least two audio signals.

The apparatus may further comprise means for rendering an output audio signal from the aligned at least two audio signals.

The means for rendering an output audio signal from the aligned at least two audio signals may comprise means for rendering segments for at least one of the at least two audio signals which match at least one defined rendering classification.

The means for rendering an output audio signal from the aligned at least two audio signals may comprise: means for defining a rending classification order; and means for rendering segments for at least one of the at least two audio signals according to the rendering classification order.

The means for segmenting the at least two audio signals according to at least two classifications may comprise means for defining at least two classifications, a classification being defined according at least one feature value range.

The means for segmenting the at least two audio signals according to at least two classifications may comprise: means for dividing at least one of the audio signals into a number of frames; means for analysing for at least one frame of the number of frames of the at least one audio signal to determine at least one feature value; and means for determining a classification for the at least one frame based on at least one defined range of feature values, wherein the at least one of the audio signals is segmented according to the classification.

The classification for the at least one frame may comprise at least one of: music; speech; and noise.

The means for selecting, for the at least two audio signals, audio signal segments based on at least one classification from the at least two classifications may comprise means for selecting audio signal segments with the music and/or speech classification.

The means for selecting, for the at least two audio signals, audio signal segments based on at least one classification from the at least two classifications may comprise: means for defining at least one selection classification; and means for selecting audio signal segments whose classification matches the at least one selection classification.

According to a third aspect there is provided an apparatus comprising: an input selector configured to select at least two audio signals; a segmenter configured to segment the at least two audio signals according to at least two classifications; a segment selector configured to select, for the at least two audio signals, audio signal segments based on at least one classification from the at least two classifications; and an aligner configured to align the selected audio signal segments, and further configured to align the at least two audio signals based on the alignment of the selected audio signal segments.

The apparatus may further comprise a renderer configured to generate a common time line incorporating the at least two audio signals.

The apparatus may further comprise a renderer configured to render an output audio signal from the aligned at least two audio signals.

The renderer may be configured to render segments for at least one of the at least two audio signals which match at least one defined rendering classification.

The renderer may comprise: a classification definer configured to define a rending classification order; and a segment renderer configured to render segments for at least one of the at least two audio signals according to the rendering classification order.

The segmenter may comprise a classifier configured to define at least two classifications, a classification being defined according at least one feature value range.

The segmenter may comprise: a framer configured to divide at least one of the audio signals into a number of frames; an analyser configured to analyse for at least one frame of the number of frames of the at least one audio signal to determine at least one feature value; and a frame classifier configured to determine the classification for the at least one frame based on at least one defined range of feature values, wherein the at least one of the audio signals is segmented according to the classification.

The classification for the at least one frame may be at least one of: music; speech; and noise.

The selector may comprise a segment selector configured to select audio signal segments with the music and/or speech classification.

The selector may comprise: a classification determiner configured to define at least one selection classification; and a classification selector configured to select audio signal segments whose classification matches the at least one selection classification.

According to a fourth aspect there is provided a method comprising: selecting at least two audio signals; segmenting the at least two audio signals according to at least two classifications; selecting, for the at least two audio signals, audio signal segments based on at least one classification from the at least two classifications; aligning the selected audio signal segments; and aligning the at least two audio signals based on the alignment of the selected audio signal segments.

The method may further comprise generating a common time line incorporating the at least two audio signals.

The method may further comprise rendering an output audio signal from the aligned at least two audio signals.

Rendering an output audio signal from the aligned at least two audio signals may comprise rendering segments for at least one of the at least two audio signals which match at least one defined rendering classification.

Rendering an output audio signal from the aligned at least two audio signals may comprise: defining a rending classification order, and rendering segments for at least one of the at least two audio signals according to the rendering classification order.

Segmenting the at least two audio signals according to at least two classifications may comprise defining at least two classifications, a classification being defined according at least one feature value range.

Segmenting the at least two audio signals according to at least two classifications may comprise: dividing at least one of the audio signals into a number of frames; analysing for at least one frame of the number of frames of the at least one audio signal to determine at least one feature value; and determining a classification for the at least one frame based on at least one defined range of feature values, wherein the at least one of the audio signals is segmented according to the classification.

The classification for the at least one frame may comprise at least one of: music; speech; and noise.

Selecting, for the at least two audio signals, audio signal segments based on at least one classification from the at least two classifications may comprise selecting audio signal segments with the music and/or speech classification.

Selecting, for the at least two audio signals, audio signal segments based on at least one classification from the at least two classifications may comprise: defining at least one selection classification; and selecting audio signal segments whose classification matches the at least one selection classification.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For better understanding of the present application, reference will now be made by way of example to the accompanying drawings in which:

FIG. 1 shows schematically a multi-user free-viewpoint service sharing system which may encompass embodiments of the application;

FIG. 2 shows schematically an apparatus suitable for being employed in embodiments of the application;

FIG. 3 shows schematically an example content co-ordinating apparatus according to some embodiments;

FIG. 4 shows a flow diagram of the operation of the example content co-ordinating apparatus shown in FIG. 3 according to some embodiments;

FIG. 5 shows schematically an example audio signal with segment classes marked according to some embodiments; and

FIG. 6 shows audio alignment examples according to some embodiments.

### EMBODIMENTS OF THE APPLICATION

The following describes in further detail suitable apparatus and possible mechanism for the provision of effective audio signal capture sharing. In the following examples, audio signals and audio capture signals are described. However it would be appreciated that in some embodiments the audio signal/audio capture is a part of an audio-video system.

The concept of this application is related to assisting in the production of immersive person-to-person communication and can include video. It would be understood that the space within which the devices record the audio signal can be arbitrarily positioned within an event space. The captured signals as described herein are transmitted or alternatively stored for later consumption where the end user can select the listening point based on their preference from the reconstructed audio space. The rendering part then can provide one or more down mixed signals from which the multiple recordings that correspond to the selective listening point. It would be understood that each recording device can record the event seen and upload or upstream the recorded content. The uploaded or upstream process can include implicitly positioning information about where the content is being recorded.

Furthermore an audio scene can be defined as a region or area within which a device or recording apparatus effectively captures the same audio signal. Recording apparatus operating within an audio scene and forwarding the captured or recorded audio signals or content to a co-ordinating or management apparatus effectively transmit many copies of the same or very similar audio signal. The redundancy of many devices capturing the same audio signal permits the effective sharing of the audio recording or capture operation.

Before it is possible to use the multi-user recorded content for various content processing methods, such as audio mixing from multiple users and video view switching from one user to the other, the content between different users must be synchronised such that they employ a common timeline or timestamp. The local device or apparatus clocks of the content from different user apparatus is required to be at least within few tens of milliseconds of each other before content from multiple user devices can be jointly processed. For example where the clocks of different user devices (and, hence, the timestamp of the creation time of the content itself) are not in synchronization then any attempt at content processing can fail (as the content processing produces poor quality signal/content) for the multi-user device recorded content.

Furthermore, the audio scene recorded by neighbouring devices is typically not the same signal. For example the various devices or apparatus physically within the same area can record the audio scene with varying quality depending on various recording issues. These recording issues can include the position of the user device in the audio scene. For example the closer the device is to the actual sound source typically the better the quality of the recording. Furthermore another issue is the surrounding ambient noise. For example crowd noise from nearby locations can negatively impact on the recording of the audio scene source. Another recording quality variable is the recording characteristics of the device. For example the quality of the microphone(s), the quality of the analogue to digital converted, and the encoder and compression used to encode the audio signal prior to transmission or storage.

Synchronization can for example be achieved using dedicated synchronization signals to time stamp the recordings. The synchronization signal can be some special beacon signal or timing information, for example the clock signal obtained through GPS satellite transmissions or cellular network time docks. However the use of a beacon signal typically requires special hardware and/or software installations which limit the applicability to multi-user device sharing services. For example recording devices become too expensive for mass use, use significant battery and processing power in receiving and determining the synchronization signals and further limits the use of existing devices for these multi-user device services (in other words older devices or low specification devices cannot use such services).

Furthermore it is known that whilst synchronization signals such as GPS signals can be used and the limitation of such signals are also known, for example they can be received only with a GPS receiver and can fail in built up areas, valleys or forested regions outdoors and indoors where the signal is not received.

Ad-hoc or non-beacon methods have been proposed for synchronisation purposes. However these methods typically do not perform well in the multi-device environment since as the number of recordings increase so does the amount of correlation calculations. Furthermore the processing or correlation calculation increase is exponential rather than linear as the number of recordings increase so requiring significant processing capacity increases as the number of recordings increase. Furthermore in the methods described in the art the time skew between multiple content recordings typically needs to be limited to tens of seconds at maximum; otherwise the computational complexity and processing requirements become overwhelming.

Added to the processing requirement issues with the synchronisation methods described in the art, the differences in the audio scene characteristics described herein impact significantly on the overall robustness of the prior art synchronisation methods. For example a signal can be aligned to the common timeline but at wrong time position or aligned even when the signal is actually not part of the common timeline at all. In such situations any subsequent content processing methods can fail or produce significantly poorer resultant output audio signals.

The purpose of the embodiments described herein is therefore to provide an apparatus which can create a common timeline, or synchronize the audio signals, from the multi-user recorded content which is robust to various deficiencies in the recorded audio scene signal.

The embodiments can be summarised furthermore as a method for organizing audio scenes from multiple devices or apparatus into common timeline. The embodiments as described herein add significant robustness to the accuracy of the timeline by cascading alignment methods and a prediction based similarity verification. The embodiments as described herein can be summarised as the following operations or steps:

Receiving audio signals
Segmenting audio signals
Selecting class from segmentation results for basis of alignment
Aligning audio signals based on selected class segment boundaries
Rendering aligned content

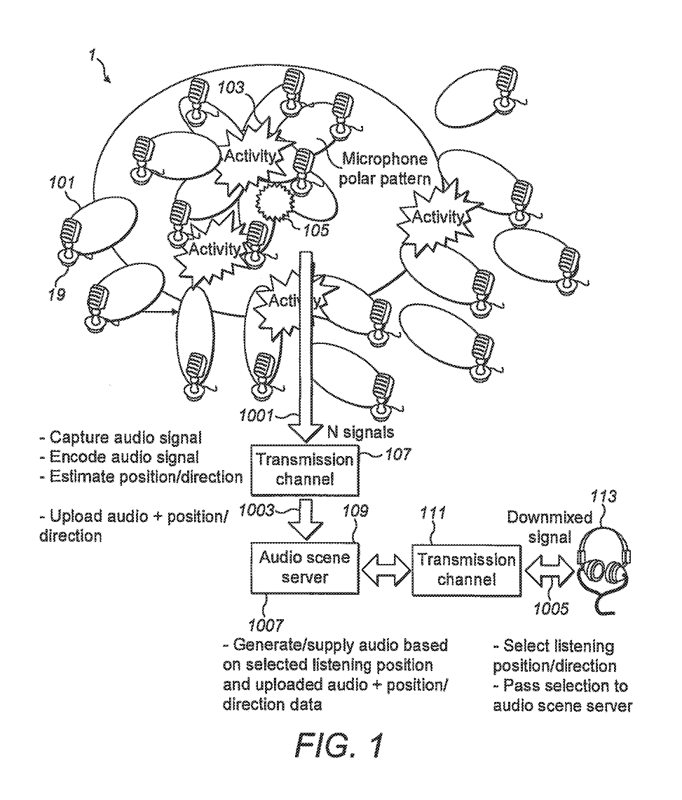

With respect to FIG. 1 an overview of a suitable system within which embodiments of the application can be located is shown. The audio space 1 can have located within it at least one recording or capturing device or apparatus 19 which are arbitrarily positioned within the audio space to record suitable audio scenes. The apparatus 19 shown in FIG. 1 are represented as microphones with a polar gain pattern 101 showing the directional audio capture gain associated with each apparatus. The apparatus 19 in FIG. 1 are shown such that some of the apparatus are capable of attempting to capture the audio scene or activity 103 within the audio space. The activity 103 can be any event the user of the apparatus wishes to capture. For example the event could be a music event or audio of a “news worthy” event. The apparatus 19 although being shown having a directional microphone gain pattern 101 would be appreciated that in some embodiments the microphone or microphone array of the recording apparatus 19 has a omnidirectional gain or different gain profile to that shown in FIG. 1.

Each recording apparatus 19 can in some embodiments transmit or alternatively store for later consumption the captured audio signals via a transmission channel 107 to an audio scene server 109. The recording apparatus 19 in some embodiments can encode the audio signal to compress the audio signal in a known way in order to reduce the bandwidth required in “uploading” the audio signal to the audio scene server 109.

The recording apparatus 19 in some embodiments can be configured to estimate and upload via the transmission channel 107 to the audio scene server 109 an estimation of the location and/or the orientation or direction of the apparatus. The position information can be obtained, for example, using GPS coordinates, cell-ID or a-GPS or any other suitable location estimation methods and the orientation/direction can be obtained, for example using a digital compass, accelerometer, or gyroscope information.

In some embodiments the recording apparatus 19 can be configured to capture or record one or more audio signals for example the apparatus in some embodiments have multiple microphones each configured to capture the audio signal from different directions. In such embodiments the recording device or apparatus 19 can record and provide more than one signal from different the direction/orientations and further supply position/direction information for each signal. With respect to the application described herein an audio or sound source can be defined as each of the captured or audio recorded signal. In some embodiments each audio source can be defined as having a position or location which can be an absolute or relative value. For example in some embodiments the audio source can be defined as having a position relative to a desired listening location or position. Furthermore in some embodiments the audio source can be defined as having an orientation, for example where the audio source is a beamformed processed combination of multiple microphones in the recording apparatus, or a directional microphone. In some embodiments the orientation may have both a directionality and a range, for example defining the 3 dB gain range of a directional microphone.

The capturing and encoding of the audio signal and the estimation of the position/direction of the apparatus is shown in FIG. 1 by step 1001.

The uploading of the audio and position/direction estimate to the audio scene server 109 is shown in FIG. 1 by step 1003.

The audio scene server 109 furthermore can in some embodiments communicate via a further transmission channel 111 to a listening device 113.

In some embodiments the listening device 113, which is represented in FIG. 1 by a set of headphones, can prior to or during downloading via the further transmission channel 111 select a listening point, in other words select a position such as indicated in FIG. 1 by the selected listening point 105. In such embodiments the listening device 113 can communicate via the further transmission channel 111 to the audio scene server 109 the request.

The selection of a listening position by the listening device 113 is shown in FIG. 1 by step 1005.

The audio scene server 109 can as discussed above in some embodiments receive from each of the recording apparatus 19 an approximation or estimation of the location and/or direction of the recording apparatus 19. The audio scene server 109 can in some embodiments from the various captured audio signals from recording apparatus 19 produce a composite audio signal representing the desired listening position and the composite audio signal can be passed via the further transmission channel 111 to the listening device 113.

The generation or supply of a suitable audio signal based on the selected listening position indicator is shown in FIG. 1 by step 1007.

In some embodiments the listening device 113 can request a multiple channel audio signal or a mono-channel audio signal. This request can in some embodiments be received by the audio scene server 109 which can generate the requested multiple channel data.

The audio scene server 109 in some embodiments can receive each uploaded audio signal and can keep track of the positions and the associated direction/orientation associated with each audio source. In some embodiments the audio scene server 109 can provide a high level coordinate system which corresponds to locations where the uploaded/upstreamed content source is available to the listening device 113. The “high level” coordinates can be provided for example as a map to the listening device 113 for selection of the listening position. The listening device (end user or an application used by the end user) can in such embodiments be responsible for determining or selecting the listening position and sending this information to the audio scene server 109. The audio scene server 109 can in some embodiments receive the selection/determination and transmit the downmixed signal corresponding to the specified location to the listening device. In some embodiments the listening device/end user can be configured to select or determine other aspects of the desired audio signal, for example signal quality, number of channels of audio desired, etc. In some embodiments the audio scene server 109 can provide in some embodiments a selected set of downmixed signals which correspond to listening points neighbouring the desired location/direction and the listening device 113 selects the audio signal desired.

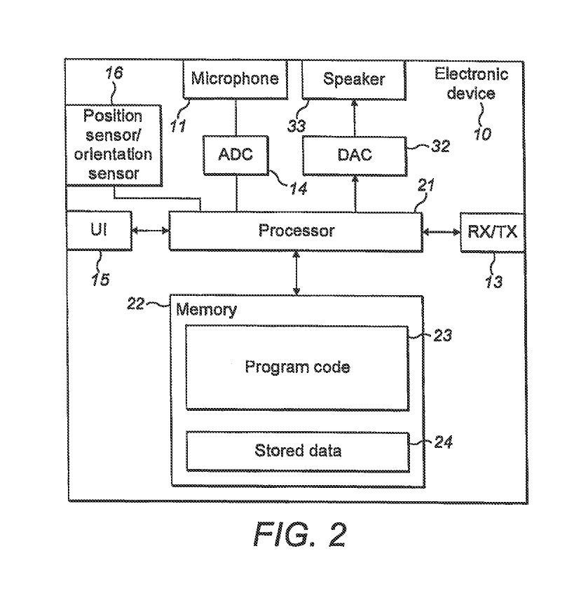

In this regard reference is first made to FIG. 2 which shows a schematic block diagram of an exemplary apparatus or electronic device 10, which may be used to record (or operate as a recording or capturing apparatus 19) or listen (or operate as a listening apparatus 113) to the audio signals (and similarly to record or view the audio-visual images and data). Furthermore in some embodiments the apparatus or electronic device can function as the audio scene server 109.

The electronic device 10 or apparatus may for example be a mobile terminal or user equipment of a wireless communication system when functioning as the recording device or listening device 113. In some embodiments the apparatus can be an audio player or audio recorder, such as an MP3 player, a media recorder/player (also known as an MP4 player), or any suitable portable device suitable for recording audio or audio/video camcorder/memory audio or video recorder.

The apparatus 10 can in some embodiments comprise an audio subsystem. The audio subsystem for example can comprise in some embodiments a microphone or array of microphones 11 for audio signal capture. In some embodiments the microphone or array of microphones can be a solid state microphone, in other words capable of capturing audio signals and outputting a suitable digital format signal. In some other embodiments the microphone or array of microphones 11 can comprise any suitable microphone or audio capture means, for example a condenser microphone, capacitor microphone, electrostatic microphone, Electret condenser microphone, dynamic microphone, ribbon microphone, carbon microphone, piezoelectric microphone, or microelectrical-mechanical system (MEMS) microphone. The microphone 11 or array of microphones can in some embodiments output the audio captured signal to an analogue-to-digital converter (ADC) 14.

In some embodiments the apparatus can further comprise an analogue-to-digital converter (ADC) 14 configured to receive the analogue captured audio signal from the microphones and outputting the audio captured signal in a suitable digital form. The analogue-to-digital converter 14 can be any suitable analogue-to-digital conversion or processing means.

In some embodiments the apparatus 10 audio subsystem further comprises a digital-to-analogue converter 32 for converting digital audio signals from a processor 21 to a suitable analogue format. The digital-to-analogue converter (DAC) or signal processing means 32 can in some embodiments be any suitable DAC technology.

Furthermore the audio subsystem can comprise in some embodiments a speaker 33. The speaker 33 can in some embodiments receive the output from the digital-to-analogue converter 32 and present the analogue audio signal to the user. In some embodiments the speaker 33 can be representative of a headset, for example a set of headphones, or cordless headphones.

Although the apparatus 10 is shown having both audio capture and audio presentation components, it would be understood that in some embodiments the apparatus 10 can comprise one or the other of the audio capture and audio presentation parts of the audio subsystem such that in some embodiments of the apparatus the microphone (for audio capture) or the speaker (for audio presentation) are present.

In some embodiments the apparatus 10 comprises a processor 21. The processor 21 is coupled to the audio subsystem and specifically in some examples the analogue-to-digital converter 14 for receiving digital signals representing audio signals from the microphone 11, and the digital-to-analogue converter (DAC) 12 configured to output processed digital audio signals. The processor 21 can be configured to execute various program codes. The implemented program codes can comprise for example audio signal segmentation or segmentation detection routines.

In some embodiments the apparatus further comprises a memory 22. In some embodiments the processor is coupled to memory 22. The memory can be any suitable storage means. In some embodiments the memory 22 comprises a program code section 23 for storing program codes implementable upon the processor 21. Furthermore in some embodiments the memory 22 can further comprise a stored data section 24 for storing data, for example data that has been encoded in accordance with the application or data to be encoded via the application embodiments as described later. The implemented program code stored within the program code section 23, and the data stored within the stored data section 24 can be retrieved by the processor 21 whenever needed via the memory-processor coupling.

In some further embodiments the apparatus 10 can comprise a user interface 15. The user interface 15 can be coupled in some embodiments to the processor 21. In some embodiments the processor can control the operation of the user interface and receive inputs from the user interface 15. In some embodiments the user interface 15 can enable a user to input commands to the electronic device or apparatus 10, for example via a keypad, and/or to obtain information from the apparatus 10, for example via a display which is part of the user interface 15. The user interface 15 can in some embodiments comprise a touch screen or touch interface capable of both enabling information to be entered to the apparatus 10 and further displaying information to the user of the apparatus 10.

In some embodiments the apparatus further comprises a transceiver 13, the transceiver in such embodiments can be coupled to the processor and configured to enable a communication with other apparatus or electronic devices, for example via a wireless communications network. The transceiver 13 or any suitable transceiver or transmitter and/or receiver means can in some embodiments be configured to communicate with other electronic devices or apparatus via a wire or wired coupling.

The coupling can, as shown in FIG. 1, be the transmission channel 107 (where the apparatus is functioning as the recording device 19 or audio scene server 109) or further transmission channel 111 (where the device is functioning as the listening device 113 or audio scene server 109). The transceiver 13 can communicate with further devices by any suitable known communications protocol, for example in some embodiments the transceiver 13 or transceiver means can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

In some embodiments the apparatus comprises a position sensor 16 configured to estimate the position of the apparatus 10. The position sensor 16 can in some embodiments be a satellite positioning sensor such as a GPS (Global Positioning System), GLONASS or Galileo receiver.

In some embodiments the positioning sensor can be a cellular ID system or an assisted GPS system.

In some embodiments the apparatus 10 further comprises a direction or orientation sensor. The orientation/direction sensor can in some embodiments be an electronic compass, accelerometer, a gyroscope or be determined by the motion of the apparatus using the positioning estimate.

It is to be understood again that the structure of the electronic device 10 could be supplemented and varied in many ways.

Furthermore it could be understood that the above apparatus 10 in some embodiments can be operated as an audio scene server 109. In some further embodiments the audio scene server 109 can comprise a processor, memory and transceiver combination.

In the following examples there are described an audio scene/content recording or capturing apparatus which correspond to the recording device 19 and an audio scene/content co-ordinating or management apparatus which corresponds to the audio scene server 109. However it would be understood that in some embodiments the audio scene management apparatus can be located within the recording or capture apparatus as described herein and similarly the audio scene recording or content capture apparatus can be a part of an audio scene server 109 capturing audio signals either locally or via a wireless microphone coupling. Similarly it would be understood that in some embodiments the audio scene management apparatus can be located within the listening or rendering apparatus as described herein.

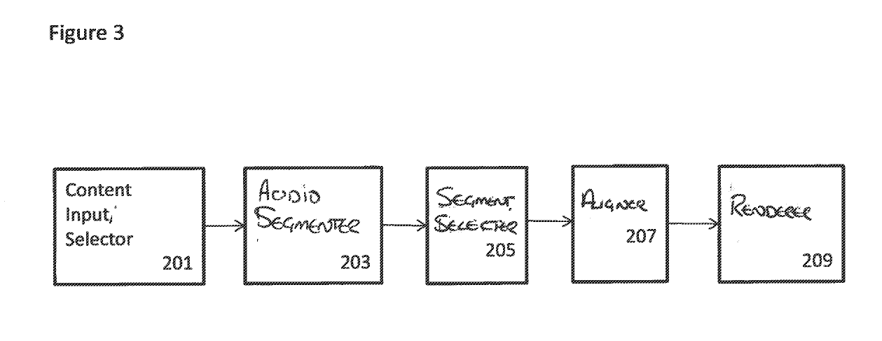

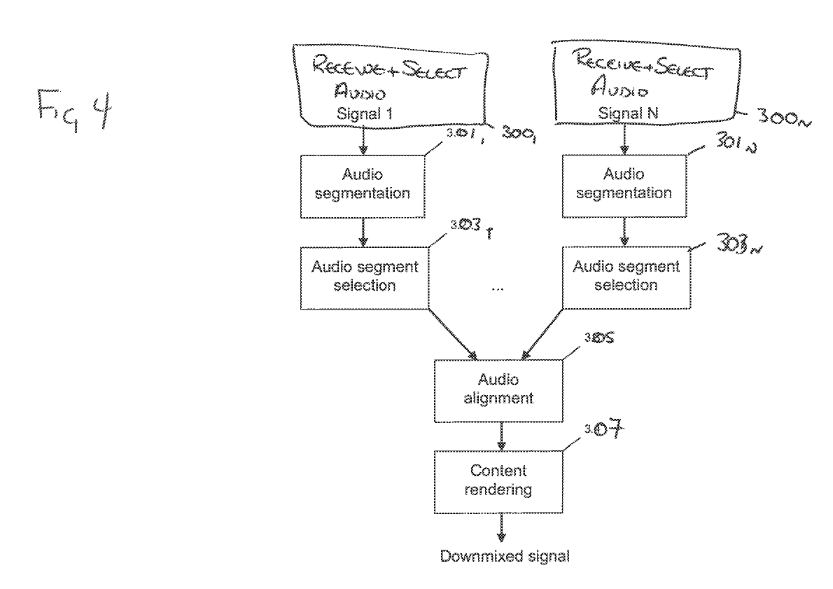

With respect to FIG. 3 an example content co-ordinating or management apparatus according to some embodiments is shown which can be implemented within the recording device, the audio scene server, or the listening device (when acting as a content aggregator). Furthermore FIG. 4 shows a flow diagram of the operation of the example content co-ordinating or management apparatus shown in FIG. 3 according to some embodiments.

In some embodiments the example content co-ordinating apparatus comprises a content input selector 201. The content input selector 201 can in some embodiments receive at least one audio signal from an external or further apparatus via the transceiver or other wire or wireless coupling to the apparatus. Furthermore in some embodiments the content input selector 201 can be configured to receive at least one further audio signal from a microphone input associated or physically connected to the apparatus (where the apparatus is also functioning as a recording or capture apparatus). In some embodiments the content input selector 201 can be configured to receive the audio signals from the memory 22 and in particular the stored data memory 24 where any edited or unedited audio signal received at an earlier time is stored. In other words the content input selector 201 can in some embodiments be configured to input real-time audio signals or near real-time audio signals (in other words audio signals which have ‘just’ been recorded) and in some embodiments be configured to input stored or archived audio signals (in other words audio signals which have been recorded and stored for later consumption).

Furthermore the content input selector 201 can be configured to select at least two of the audio signals from different recording sources (for example two separate audio signals from different further apparatus, or an audio signal from a further apparatus and the microphone audio signals from the apparatus) to be co-ordinated or aligned. In some embodiments the selected audio signals (to be co-ordinated or aligned are passed to the audio segmenter 203. It would be understood that in some embodiments the audio selection can be a pairwise selection leading to a pairwise alignment, however any suitable selection method can be implemented for example a plurality of audio signals can be selected and aligned or all of the available audio signals used.

The operation of receiving and selecting at least two audio signals is shown in FIG. 4 by step 300. For example as shown in FIG. 4 an audio signal 1 and audio signal N is shown being selected in Step 300₁ and 300_{N} respectively.

In some embodiments the example content co-ordinating apparatus comprises an audio segmenter 203. The audio segmenter is configured to receive the selected audio signals and segment the received audio signals into a number of defined classes. In other words the audio segmenter 203 can be configured for a received audio signal to determine where or when a defined audio type occurs within the audio signal. The purpose of the audio segmenter 203 is to determine segments of audio from the audio signal such that the subsequent audio signal alignment and processing can analyse segments which are better suited for alignment so that unnecessary processing of ill-suited segments are not analysed. Furthermore in some embodiments the segmentation of the audio signals can be used to determine a ‘rough’ initial alignment of the audio signals.

The audio segmenter 203 can in some embodiments comprise a suitable classifier configured to analyse the audio signal and determine a classification of the audio signal segment.

In some embodiments the classifier is configured to analyse the audio signal on a frame by frame (or sub-frame by sub-frame) basis, and for each frame (or sub-frame) determine at least one possible feature value. Each classification or class value can have an assigned or associated feature value range against which the determined feature value or feature values can then be compared to determine a classification or class for the frame (or sub-frame). For example the feature values for a frame can in some embodiments be located within a space or vector map within which are determined classification boundaries defining audio classifications and from which can be determined a classification for each frame.

For example a classifier which can be used in some embodiments is the one described in “Features for Audio and Music Classification” by McKinney and Breebaart, Proc. 4th Int. Conf. on Music Information Retrieval, which is configured to determine classifications such as Classical Music, Jazz, Folk, Electronica, R&B, Rock, Reggae, Vocal, Speech, Noise, and Crowd Noise.

The analysis features can in some embodiments be any suitable features such as spectral features such as cepstral coefficients, frequency warping, magnitude warping, Mel-frequency cepstral coefficients, spectral centroid, bandwidth, temporal features such as rise time, onset asynchrony at different frequencies, frequency modulation (amplitude and rate), amplitude modulation (amplitude and rate), zero crossing rate, short-time energy values, etc.

In some embodiments the features are selected for analysis according to any suitable manner, for example data normalisation, Sequential backward selection (SBS), principal component analysis, Eigenanalysis (determining the eigenvectors and eigenvalues of the data set), or feature transformation (linear or otherwise) can be used.

The classifier can in some embodiments generate classification from the feature values according to any suitable manner, such as for example by a supervised (or taught) classifier or unsupervised classifier. The classifier can for example in some embodiments be configured to use a minimum distance classification method. In some embodiments the classifier be configured to use a k-nearest neighbour (k-NN) classifier where the k nearest neighbours are picked to the feature value x and then choose the class which was most often picked. In some embodiments the classifier employs statistical classification techniques where the feature vector value is interpreted as a random variable whose distribution depends on the class (for example by applying Baysian, Gausian mixture models, or maximum a posteriori MAP, Hidden Markov model HMM, methods).

The exact set of classes or classifications can in some embodiments vary depending on the audio signals being analysed and the environment within which the audio signals were recorded or are being analysed. For example in some embodiments there can be a user interface input selecting the set of classes, or the set of classes can be chosen by an automatic or semi-automatic means.

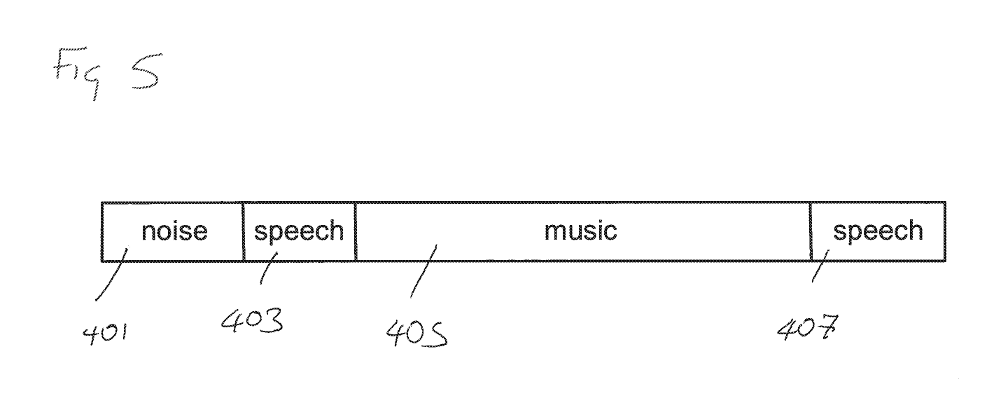

With respect to FIG. 5 an example audio signal time line is shown wherein the class set is defined as noise, speech, and music.

In some embodiments the segmenter 203 and/or classifier is further configured to allocate or associate the determined class or classification with the audio signal. For example with respect to FIG. 5 the example audio signal time line is shown segmented or in other words frames, sub-frames, parts or portions of the audio signal have associated class or classification labels. Thus for example a first segment 401 is determined as being ‘noise’ and has an associated ‘noise’ class label, a second segment 403 is determined as being ‘speech’ and has an associated ‘speech’ label, a third segment 405 is determined as being ‘music’ and has an associated ‘speech’ label and a fourth segment 407 is also determined to be ‘speech’ and has an associated ‘speech’ label.

In such a way embodiments can have an advantageous result as it can be beneficial to apply alignment to segments which contain the desired segment such as ‘music’ as music typically has rich set of features that characterize the signal as opposed to, ‘noise’ or ‘crowd noise’ which can be difficult to align as the signal characteristics differ only partially from each other. Furthermore by limiting the alignment to a specified segment(s), the actual alignment processing time can be reduced.

In some embodiments the segmenter 203 can be configured to output the audio signal(s) and the determined segment labels to the segment selector 205.

The operation of segmenting the at least two audio signals is shown in FIG. 4 by step 301. For example as shown in FIG. 4 an audio signal 1 and audio signal N is shown being segmented in Step 301₁ and 301_{N} respectively.

In some embodiments the example content co-ordinating apparatus comprises a segment selector 205. The segment selector 205 is configured to receive the output from the audio segmenter 203, for example the audio signal and associated segment labels and select or locate segments from the signal for alignment.

In some embodiments the segment selector 205 can be configured to select specific or defined classes. Thus for example in some embodiments the segment selector 205 can be configured to select audio signal segments where the segment label is determined to enable easier alignment, for example with respect to the example shown in FIG. 5 the determined classes are speech or music classes and so the segment selector 205 is configured to select the speech and/or music class defined audio segments for further processing by the aligner.

In some other embodiments the segment selector is configured to select the audio signal segments which have a class or classification which dominates the signal. For example with respect to the example shown in FIG. 5 the music class is the most common and thus is selected over the other classes and the third audio signal segment 405 selected and passed to the aligner.

In some embodiments the segment selector 205 can be configured to operate as a segment or audio signal filter configured to prevent audio signals which are likely to be problematic or produce erroneous results from being aligned. For example in some embodiments the segment selector can be configured to filter the audio signal such that where the audio signal contains very few or no preference classes then the signal is excluded from alignment and also from further processing such as multi-user content rendering as the signal does not contain any meaningful content for rendering purposes. For example in some embodiments where an audio signal has been captured or recorded from a faulty or damaged apparatus or where there is significant background noise preventing a good recording being generated.

Thus in other words audio signal segments can in some embodiments be selected because of their ability or suitability to be aligned and audio signals can be screened or filtered where there is little or no suitable content.

In some embodiments the segment selector 205 can be configured to generate an approximate or rough alignment value by selecting audio signal segments from different sources with the same (specific or defined) classes. Thus for example the segment selector 205 can be configured to select a segment with a defined class from a first audio signal, the audio signal segment with an associated time stamp value and the same defined class from a second audio signal with a difference associated time stamp value. From the difference in time stamp values an approximate value for the alignment delay between the first and second audio signals can be defined which can be used by the aligner to improve the estimation.

The operation of selecting segments from the at least two audio signals is shown in FIG. 4 by step 303. For example as shown in FIG. 4 an audio signal 1 and audio signal N is shown having segments selected in Step 303₁ and 303_{N} respectively.

In some embodiments the example content co-ordinating apparatus comprises an aligner 207. The aligner 207 is configured to receive the selected segments from different audio signals from the segment selector and configured to align the audio signals using the segments. In other words the aligner 207 in some embodiments comprises a time offset determiner configured to determine a time difference or offset between two of the audio signals by determining a time difference or offset between the selected segments of the audio signals.

The time difference or offset is the time value which when applied to one of the audio signals (or specifically the selected segment audio signal) to delay the audio signal produces the best match with the other of the audio signals.

Furthermore in some embodiments the aligner 207 is configured to determine which of the audio signals (or specifically the selected segment audio signal) is delayed with respect to the other audio signal(s).

The aligner can in some embodiments receive the at least two independently recorded audio signals and outputs synchronized audio signals.

The aligner 207 can in some embodiments employ variable length framing of the audio signals, selecting a base audio signal and then aligning the remainder of the audio signals with the base audio signal.

The aligner therefore in some embodiments comprises a variable length framer. The variable length framer may receive the at least two audio signals and generate framed recorded signal values from the audio signals.

An example of the variable length framer carrying out variable length framing may be according to the following equation:

$${vlf}_{i , j} ( k ) = \{ \begin{matrix}\frac{1}{{f}_{j}} \cdot {\sum }_{h = 0}^{{f}_{j} - 1} {b}_{i} ( k \cdot {f}_{j} + h ) , & vlf\_idx = 1 \\ \frac{1}{{f}_{j}} \cdot {\sum }_{h = 0}^{{f}_{j} - 1} ( {{b}_{i} ( k \cdot {f}_{j} + h )}^{2} \cdot sgn ( {b}_{i} ( k \cdot {f}_{j} + h ) ) ) , & otherwise\end{matrix} , \\ 0 \leq k \leq \frac{N}{{f}_{j}} , 0 \leq j < M \\ sgn ( x ) = \{ \begin{matrix}1 , & x \geq 0 \\ - 1 , & otherwise\end{matrix}$$

where vlf_{i,j}(k) is an output sample value for the first number of recorded signal data samples for the i'th audio signal, fⱼ the first number (otherwise known as the input mapping size), bᵢ(k·fⱼ+h) the input sample value for the (k·fⱼ+h) sample. For each mapping or frame k·fⱼ defines the first input sample index and k·fⱼ+fⱼ−1 the last input sample index. The index k defines the output sample or variable frame index.

Thus as described previously for a time period T where there are N input sample values, the variable length framer can be configured to output N/fⱼ output sample values each of which is formed dependent on fⱼ adjacent input sample values.

The index vlf_idx indicates the run time mode for the variable length framing. In some embodiments the value of vif_idx is set to 0 where

$$\frac{{f}_{j}}{S} < 2 ms ,$$

otherwise the value of vlf_idx is set to 1. The run-time mode may indicate the calculation path for the variable length framing operation. This is, whether the output value of vlf_{i,j}(k) is calculated from the amplitude envelope directly (vlf_idx==1) or from the sign adjusted energy envelope (vlf_idx!1=1). The decision which mode is to be used depends on the duration of the fⱼ. If the duration of fⱼ is less than 2 milliseconds the amplitude envelope calculation path may be selected, otherwise the energy envelope calculation path may be used. In other words, for small input mapping sizes it is more advantageous to track the amplitude envelope than the energy envelope. This may improve the resilience to false synchronization results.

The variable length framer can in some embodiments be configured to repeat the operation of variable length framing for each of the number of audio signals to generate an output for each of the selected audio signals so that the output samples for each of the selected audio signals have the same number of sample values for the same time period. The operation of the variable length framer can in some embodiments be such that all of the selected segment audio signals are variable length framed in a serial format, in other words one after another. In some embodiments the operation of the variable length framer can be such that more than one of the selected segment audio signals can be processed at the same time or substantially at the same time to speed up the variable length processing for the time period in question.

The output of the variable length framer may be passed to an indicator selector.

The aligner 207 can in some embodiments comprise an indicator selector 303 configured to receive the variable length framed sample values for each of the selected space of audio signals and generate a time alignment indicator for each audio signal.

The indicator selector can in some embodiments be configured to generate the time alignment indicator tInd for the i'th signal and for all variable time frame sample values j from 0 to M using the following equation.

tInd_{i,j}(k)=max_{τ}{vlf_{i,j},vlf_{k,j})} 0≦i<U, 0≦k<U, 0≦j<M

where max_{τ} maximises the correlation between the given signals with respect to the delay τ. This maximisation function locates the delay τ where the signals are best time aligned. The function may in some embodiments be defined as

$${max}_{τ} \{ \overline{x} , \overline{y} \} = {max}_{lag} ( x {Corr}_{lag} ) , 0 \leq lag < \frac{{T}_{upper} \cdot S}{{f}_{j}}$$

$$x {Corr}_{d} = \vert \frac{{\sum }_{m = 0}^{{wSize}_{j} - 1} x ( m ) \cdot y ( d \cdot {f}_{j} + m )}{\sqrt{{\sum }_{m = 0}^{{wSize}_{j} - 1} {y ( d \cdot {f}_{j} + m )}^{2}}} \vert$$

where Tᵤₚₚₑᵣ defines the upper limit for the delay in seconds. In suitable embodiments, the upper limit may be set to two seconds as this has been found to be a fair value for the delay in practical recording and networking conditions.

Furthermore, wSizeⱼ describes the number of items used in the maximum calculation for each fⱼ. In some embodiments, the number of items used in the maximisation calculation may be about T_{window}=2.5 s which corresponds to

$${wSize}_{j} = {T}_{window} \cdot ( \frac{S}{{f}_{j}} )$$

in samples for each fⱼ. The above equation as performed in embodiments therefore returns the value “lag” which maximises the correlation between the signals. Furthermore the equation:

tCorr_{i,j}(k)=xCorr_{τ}{vlf_{i,j},vlf_{k,j})} 0≦i<U, 0≦k<U, 0≦j<M

may provide the correlation value.

The indicator selector can in some embodiment be configured to pass the generated time alignment indicator (tInd) values to a base signal determiner.

The aligner 207 can in some embodiments comprise a base signal determiner which can be configured to receive the time alignment indicator values from the indicator selector and indicate which of the received selected audio signal segments are suitable to synchronize the remainder of the selected audio signal segments to.

The base signal determiner can in some embodiment be configured to firstly generate a series of time aligned indicators from the time alignment indicator values. For example the time aligned indicators can in some embodiments be a time aligned index average, a time aligned index variance and a time aligned index ratio which can be generated by the base signal determiner according to the following three equations.

$${tIndAve}_{i , j} = \frac{1}{M} \cdot {\sum }_{k = 0}^{M - 1} {tInd}_{i , k} ( j ) , 0 \leq i < U , 0 \leq j < U$$

$${tIndVar}_{i , j} = \frac{1}{M} \cdot {\sum }_{k = 0}^{M - 1} ( {tInd}_{i , k} ( j ) - {tIndAve}_{i , j} ) , 0 \leq i < U , 0 \leq j < U$$

$$tIndRatio ( i ) = {\sum }_{j = 0}^{U - 1} \frac{{tIndVar}_{i , j}}{{tIndAve}_{i , j}} , 0 \leq i < U$$

The base signal determiner further can be configured to sort the indicator tIndRatio in increasing order of importance. For example the base signal determiner can in some embodiments be configured to sort the indicator tIndRatio so that the ratio value having the smallest value appears first, the ratio value having the second smallest value appears second and so on. The base signal determiner can in some embodiments be configured to output the sorted indicator as the ratio vector tIndRatioSorted. The base signal determiner furthermore can be configured to also record the order of the time indicator values tIndRatio by generating an index tIndRatioSortedIndex which contains the corresponding original position indices for the sorted result. Thus if the smallest ratio value was found at index 2, the next smallest at index 5, and so on the base signal determiner can in some embodiments be configured to generate a vector with the values [2, 5, . . . ].

The base signal determiner can in some embodiments be further configured to use the generated indicators to determine the base signal according to the following equation:

base_signal_{—}idx=tIndRatioSortedIndices(0)

time_align(base_signal_{—}idx)=0

The base signal determiner can in some embodiments be configured to also determine the time alignment factors for the other audio signals from the average time alignment indicator values according to the following equation:

time_align(i)=tIndAve_{base}_{_{—}}_{signal}_{_{—}}_{idx,i}, 0<i<U, i≠base_signal_{—}idx

The base signal determiner in some embodiments can be configured to pass the base signal indicator value base_signal_idx and also the time alignment factor values time_align for the remaining recorded signals to a signal synchronizer.

The aligner 207 can in some embodiments comprise a signal synchronizer configured to receive the audio signals and the base signal indicator value and the time alignment factor values for the remaining audio signals. The signal synchroniser can in some embodiments be configured to synchronize the recorded signals by adding the determined time alignment value to the current time indices of each of the remaining audio signals.

It would be understood that the aligner 207 as described herein is one example of alignment and any suitable alignment of the selected segment audio signals can be performed.

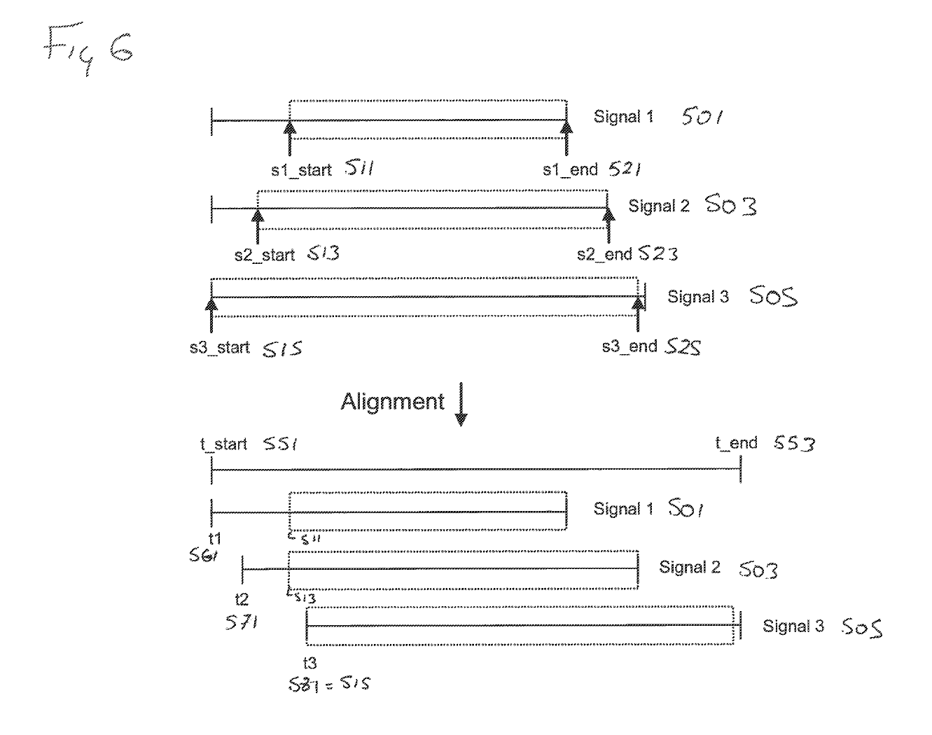

With respect to FIG. 6 an example of the alignment process for 3 input signals is shown. The input consists of three audio signals (labelled as Signal 1 501, Signal 2 503, and Signal 3 505), from which the audio signals are segmented and a segment from each audio signal with a desired class is selected. In the following example the selected segments represent music segments of the audio signal.

The segment boundaries for each signal are also shown in FIG. 6. For Signal 1 501, the ‘music’ segment boundaries are from s1_start 511 to s1_end 521; for signal 2 503, the ‘music’ segment boundaries are from s2_start 513 to s2_end 523; and for signal 3 505, the ‘music’ segment boundaries are from s3_start 515 to s3_end 525.

The selected segment parts of the audio signals are then aligned, in other words the alignment considers only the selected or marked segments of the audio signals when aligning the signals.

The lower part of FIG. 6 illustrates the common timeline for the three audio signals after alignment is completed. The timeline spans from t_start 551 to t_end 553 and the start times for signal 1 501 is t1 561, signal 2 is t2 571 and signal 3 is t3 581. The start times shown in FIG. 6 are based on the alignment results are t1+s1_start, t2+s2_start and t3+s3_start as those are the start times of the specified segments and those start times can easily be extended to cover the entire signal even though only a portion of the audio signal was actually used in the alignment.

The output of the aligner 207 can be passed to the render 209 or in some embodiments be stored for processing at a later time.

The operation of aligning the audio signals is shown in FIG. 4 by step 307.

In some embodiments the example content co-ordinating apparatus comprises a renderer 209. The renderer 209 can be configured to receive the aligned audio signals or aligned content from the aligner 207 for further processing.

For example in some embodiments the aligned content is rendered for end user consumption.

For example renderer comprises a viewpoint receiver/buffer. The viewpoint receiver/buffer can in some embodiments be configured to receive from an end user apparatus data in the form of positional or recording viewpoint information signal—in other words the apparatus may communicate a request to hear or view the event from a specific recording device or from a specified position. Although this is discussed hereafter as the viewpoint it would be understood that this applies to audio only as well as audio-visual data. Thus in embodiments the data may indicate for selection or synthesis a specific recording device from which audio or audio-visual recorded signal data is to be selected or a position such as a longitude and latitude or other geographical co-ordinate system.

The renderer can in some embodiments further comprise a viewpoint synthesizer or selector signal processor. The viewpoint synthesizer or selector signal processor can be configured to receive the viewpoint selection information and select or synthesize suitable audio or audio-visual data to be sent to the end user apparatus to provide the end user apparatus with the content experience desired.

In some embodiments where specific location/directions are specified where there is no apparatus present a synthesis of more than one nearby synchronized audio signal can be generated. For example the renderer can generate a weighted averaging of the synchronized audio signals nearby the specific location/direction may be used to provide an estimate of the audio or audio-visual data which may have been recorded at the specified position.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings.

Although the above has been described with regards to audio signals, or audio-visual signals it would be appreciated that embodiments may also be applied to audio-video signals where the audio signal components of the recorded data are processed in terms of the determining of the base signal and the determination of the time alignment factors for the remaining signals and the video signal components may be synchronised using the above embodiments of the invention. In other words the video parts may be synchronised using the audio synchronisation information.

It shall be appreciated that the term user equipment is intended to cover any suitable type of wireless user equipment, such as mobile telephones, portable data processing devices or portable web browsers.

Furthermore elements of a public land mobile network (PLMN) may also comprise apparatus as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-22. (canceled)

23. Apparatus comprising at least one processor and at least one memory including computer code for one or more programs, the at least one memory and the computer code configured to with the at least one processor cause the apparatus to at least perform:
select at least two audio signals;
segment the at least two audio signals according to at least two classifications;
select, for the at least two audio signals, audio signal segments based on at least one classification from the at least two classifications;
align the selected audio signal segments; and
align the at least two audio signals based on the alignment of the selected audio signal segments.

24. The apparatus as claimed in claim 23, further caused to generate a common time line incorporating the at least two audio signals.

25. The apparatus as claimed in claim 23, further caused to render an output audio signal from the aligned at least two audio signals.

26. The apparatus as claimed in claim 25, wherein the apparatus caused to render an output audio signal from the aligned at least two audio signals causes the apparatus to render segments for at least one of the at least two audio signals which match at least one defined rendering classification.

27. The apparatus as claimed in claim 25, wherein the apparatus caused to render an output audio signal from the aligned at least two audio signals causes the apparatus to:
define a rending classification order; and
render segments for at least one of the at least two audio signals according to the rendering classification order.

28. The apparatus as claimed in claim 23, wherein the apparatus caused to segment the at least two audio signals according to at least two classifications causes the apparatus to define at least two classifications, a classification being defined according at least one feature value range.

29. The apparatus as claimed in claim 23, wherein the apparatus caused to segment the at least two audio signals according to at least two classifications causes the apparatus to:
divide at least one of the audio signals into a number of frames;
analyse for at least one frame of the number of frames of the at least one audio signal to determine at least one feature value; and
determine a classification for the at least one frame based on at least one defined range of feature values, wherein the at least one of the audio signals is segmented according to the classification.

30. The apparatus as claimed in claim 29, wherein the classification for the at least one frame is at least one of:
music;
speech; and
noise.

31. The apparatus as claimed in claim 30, wherein the apparatus caused to select, for the at least two audio signals, audio signal segments based on at least one classification from the at least two classifications causes the apparatus to select audio signal segments with the music and/or speech classification.

32. The apparatus as claimed in claim 23, wherein the apparatus caused to select, for the at least two audio signals, audio signal segments based on at least one classification from the at least two classifications causes the apparatus to:
define at least one selection classification; and
select audio signal segments whose classification matches the at least one selection classification.

33. A method comprising:
selecting at least two audio signals;
segmenting the at least two audio signals according to at least two classifications;
selecting, for the at least two audio signals, audio signal segments based on at least one classification from the at least two classifications;
aligning the selected audio signal segments; and
aligning the at least two audio signals based on the alignment of the selected audio signal segments.

34. The method as claimed in claim 33, further comprising generating a common time line incorporating the at least two audio signals.

35. The method as claimed in claim 33, further comprising rendering an output audio signal from the aligned at least two audio signals.

36. The method as claimed in claim 35, wherein rendering an output audio signal from the aligned at least two audio signals comprises rendering segments for at least one of the at least two audio signals which match at least one defined rendering classification.

37. The method as claimed in claim 35, wherein rendering an output audio signal from the aligned at least two audio signals comprises:
define a rending classification order; and
render segments for at least one of the at least two audio signals according to the rendering classification order.

38. The method as claimed in claim 33, wherein segmenting the at least two audio signals according to at least two classifications comprises defining at least two classifications, a classification being defined according at least one feature value range.

39. The method as claimed in claim 33, wherein segmenting the at least two audio signals according to at least two classifications comprises:
dividing at least one of the audio signals into a number of frames;
analysing for at least one frame of the number of frames of the at least one audio signal to determine at least one feature value; and
determining a classification for the at least one frame based on at least one defined range of feature values, wherein the at least one of the audio signals is segmented according to the classification.

40. The method as claimed in claim 39, wherein the classification for the at least one frame is at least one of:
music;
speech; and
noise.

41. The method as claimed in claim 40, wherein selecting, for the at least two audio signals, audio signal segments based on at least one classification from the at least two classifications comprises:
defining at least one selection classification; and
selecting audio signal segments whose classification matches the at least one selection classification.

42. The method as claimed in claim 33, wherein selecting, for the at least two audio signals, audio signal segments based on at least one classification from the at least two classifications may comprise:
defining at least one selection classification; and
selecting audio signal segments whose classification matches the at least one selection classification.
